(19) United States
(12) Patent Application Publication
(10) Pub. No.: US 2003/0012711 A1
(43) Pub. Date: Jan. 16, 2003

(54) Honeycomb monolith catalyst support for catalytic distillation reactor

(75) Inventors: Todd H. Harkins, Ponca City, OK (US); Kenneth M. York, Ponca City, OK (US); Joe D. Allison, Ponca City, OK (US); Harold A. Wright, Ponca City, OK (US)

Correspondence Address: DAVID W. WESTPHAL, CONOCO PHILLIPS, P.O. BOX 4783, HOUSTON, TX, 77210-4783, US

(73) Assignee: Conoco Inc., Houston, TX

(21) Appl. No.: 10/150,327

(22) Filed: May 16, 2002

Related U.S. Application Data
(63) Continuation-in-part of application No. 09/714,675, filed on Nov. 16, 2000.
(60) Provisional application No. 60/291,922, filed on May 17, 2001.
(60) Provisional application No. 60/166,025, filed on Nov. 17, 1999.

(51) Int. Cl. B01J 8/04; B01J 35/04

(52) U.S. Cl. 422/190; 422/180; 422/189; 422/211; 422/222

(57) ABSTRACT

An apparatus and method is disclosed for producing hydrocarbons according to the Fischer-Tropsch process. The apparatus comprises a catalytic distillation reactor where reactants are fed into the catalytic distillation reactor to undergo catalytic reaction to form hydrocarbons. Physical separation of the unreacted materials and products occurs simultaneously in the catalytic distillation reactor. The catalytic distillation reactor is divided into reaction chambers so as to optimize control of the reaction and the distribution of hydrocarbon products. A monolith, such as a foam monolith or a honeycomb monolith, preferably a honeycomb monolith, is disposed with said reaction chamber serves both as catalyst support and as distillation packing material. A honeycomb monolith preferably includes channels having an axis disposed at a nonzero angle with respect to the axis of a reaction chamber containing the honeycomb monolith. External heat exchangers are provided for the recovery of the heat generated in the reaction.

### CROSS REFERENCE TO RELATED APPLICATIONS

The present application claims the benefit of priority from 35 U.S.C. 111(b) provisional application Serial No. 60/291,922, filed May 17, 2001, entitled Honeycomb Monolith Catalyst Support for Catalytic Distillation Reactor. Further, the present applications is a continuation-in-part application of U.S. utility application Ser. No. 09/714,675, filed Nov. 16, 2000, entitled Catalytic Distillation Reactor, which claims the benefit of priority from 35 U.S.C. 111(b) provisional application Serial No. 60/166,025 filed Nov. 17, 1999, entitled Catalytic Distillation Reactor for Fischer-Tropsch Synthesis. Each of the above-listed applications is hereby incorporated herein by reference for all purposes.

### STATEMENT REGARDING FEDERALLY SPONSORED RESEARCH OR DEVELOPMENT

Not applicable.

### FIELD OF THE INVENTION

The present invention relates to a method and apparatus for converting synthesis gas, i.e., a mixture of carbon monoxide and hydrogen, to hydrocarbons, typically referred to as the Fischer-Tropsch reactions or the Fischer-Tropsch process. Particularly this invention relates to the use of a catalytic distillation reactor to achieve both reaction of the syngas and separation of the hydrocarbon product. Separation occurs through distillation and other mass transfer techniques. The invention also relates to the use of various catalyst materials to promote and control the Fischer-Tropsch reaction. In particular, a monolith catalyst support, preferably a honecomb monolith, also acts a packing material for enhancing separation.

### BACKGROUND OF THE INVENTION

Large quantities of methane, the main component of natural gas, are available in many areas of the world. Methane can be used as a starting material for the production of other hydrocarbons. The conversion of methane to hydrocarbons is typically carried out in two steps. In the first step methane is reformed with water or partially oxidized with oxygen to produce carbon monoxide and hydrogen (i.e., synthesis gas or syngas). In a second step, the syngas is converted to hydrocarbons.

This second step, the preparation of hydrocarbons from synthesis gas, is well known in the art and is usually referred to as Fischer-Tropsch synthesis, the Fischer-Tropsch process, or Fischer-Tropsch reaction(s). Catalysts for use in such synthesis usually contain a catalytically active metal from one of the Groups 8, 9, or 10 (in the New notation of the periodic table of the elements, which is followed throughout). In particular, iron, cobalt, nickel, and ruthenium have been abundantly used as the catalytically active metals. Cobalt and ruthenium have been found to be most suitable for catalyzing a process in which synthesis gas is converted to primarily hydrocarbons having five or more carbon atoms (i.e., where the C₅₊ selectivity of the catalyst is high).

The Fischer-Tropsch reaction involves the catalytic hydrogenation of carbon monoxide to produce a variety of products ranging from methane to higher alkanes and aliphatic alcohols. The methanation reaction was first described in the early 1900's. The later work by Fischer and Tropsch dealing with higher hydrocarbon synthesis was described in the 1920's.

The process has been considered for the conversion of carbonaceous feedstock, e.g., coal or natural gas, to higher value liquid fuel or petrochemicals. The first major commercial use of the Fischer-Tropsch process was in Germany during the 1930's. More than 10,000 B/D (barrels per day) of products were manufactured with a cobalt based catalyst in a fixed-bed reactor. This work has been described by Fischer and Pichler in German Patent 731,295 issued Aug. 2, 1936.

Motivated by production of high-grade gasoline from natural gas, research on the possible use of the fluidized bed for Fischer-Tropsch synthesis was conducted in the United States in the mid-1940s. Based on laboratory results, Hydrocarbon Research, Inc. constructed a dense-phase fluidized bed reactor, the Hydrocol unit, at Carthage, Tex., using powdered iron as the catalyst. Due to disappointing levels of conversion, scale-up problems, and rising natural gas prices, operations at this plant were suspended in 1957. Research has continued, however, on developing Fischer-Tropsch reactors such as slurry-bubble columns, as disclosed in U.S. Pat. No. 5,348,982 issued Sep. 20, 1994.

Commercial practice of the Fischer-Tropsch process has continued from 1954 to the present day in SASOL plants operated in South Africa. These plants use iron-based catalysts, and produce gasoline in relatively high-temperature fluid-bed reactors and wax in relatively low-temperature fixed-bed reactors.

Despite the research that has been done to date, the need exists for further improvement in commercial Fischer-Tropsch processes. For example, research is continuing on the development of more efficient Fischer-Tropsch catalyst systems and reaction systems that increase the selectivity for high-value hydrocarbons in the Fischer-Tropsch product stream. In particular, a number of studies describe the behavior of iron, cobalt or ruthenium based catalysts in various reactor types, together with the development of catalyst compositions and preparations.

There are significant differences in the molecular weight distributions of the hydrocarbon products from different Fischer-Tropsch reaction systems. Product distribution or product selectivity depends heavily on the type and structure of the catalysts and on the reactor type and operating conditions. Accordingly, it is highly desirable to maximize the selectivity of the Fischer-Tropsch synthesis to the production of high-value liquid hydrocarbons, such as hydrocarbons with five or more carbon atoms per hydrocarbon chain. These hydrocarbons, which correspond to gasoline or diesel products, are expected to be in great demand.

Traditional methods of Fischer-Tropsch synthesis produce a range of hydrocarbons. This range of hydrocarbons based on the carbon chain length of the hydrocarbon is discussed in U.S. Pat. No. 4,619,910, which is incorporated herein by reference. This well-known distribution is known as the Anderson-Schulz-Flory distribution. In general, the range of hydrocarbons produced in Fischer-Tropsch processes may be characterized by the Anderson-Schulz-Flory distribution with a suitable value for the parameter alpha, regardless of catalyst type.

Because of the range of hydrocarbon products, typical systems that use the Fischer-Tropsch process provide a separation stage that follows the reaction stage. The separation stage is often one or more distillation columns. The distillation columns separate the hydrocarbon product into fractions according to boiling point. The lighter hydrocarbons, having lower boiling points, will vaporize and pass to the overhead region of a distillation column, where they can be removed as one product stream. The heavier hydrocarbons, having higher boiling points, will condense and fall to the lower region of the distillation column, where they can be removed as a separate product stream. In addition, any one or more of the product streams having intermediate compositions can be removed from the column at intermediate points between the top and the bottom and may then be sent to other columns for further separation if desired.

Paraffins constitute a specific type of reaction product of the Fischer-Tropsch synthesis included within the hydrocarbons. Paraffins generally do not react further under conditions applicable to the Fischer-Tropsch synthesis. Water is also produced during Fischer-Tropsch synthesis. Recent research indicates that water can deactivate a Fischer-Tropsch catalyst in certain circumstances. Rothaemel, Hanssen, Blekkan, Schanke and Holmen, The Effect of Water on Cobalt Fischer-Tropsch Catalysts Studied by Steady-State Isotropic Transient, Kinetic Analysis, 38 Catalysis Today 79-84 (1997); Schanke, Hilmen, Bergene, Kinnari, Rytter, Adnanes and Holmen, Reoxidation and Deactivation of Supported Cobalt Fischer-Tropsch Catalysts, Energy & Fuels, Vol. 10 No. 4 (July/August 1996) p. 867-872.

In addition, the catalytic Fischer-Tropsch synthesis, when practiced on a commercial scale, generates heat that must be removed from the reaction vessel. Fischer-Tropsch synthesis reactions are highly exothermic, and reaction vessels must be designed with adequate heat exchange capacity. Large scale reactors, which potentially offer the economic advantages that come with higher volumes, must presently include, at significant cost, sufficient heat transfer equipment within the reactor to remove the heat generated during the reaction. The traditional method for doing this, and a method that may be used in the present invention, is to place heat removal equipment inside the reaction vessel. A typical internal heat removal arrangement comprises a system of tubes within one or more reaction chambers. The tubes contain a fluid such as water, or any other acceptable fluid, which acts as the heat exchange medium. In operation, the heat generated within the reaction chamber passes through the heat exchange tubes and heats the fluid therein. The heat exchange fluid is then pumped outside the reaction vessel, where the heat is released, preferably through a heat exchanger. This process can be carried out continuously, with the heat exchange fluid circulating through the reaction chamber. A shortcoming of the internal heat exchange process is that the internal heat exchange tubes occupy reactor space. Internal heat removal equipment may therefore decrease the reactor volume that is available for Fischer-Tropsch synthesis, thus limiting the capacities and efficiencies for a given reactor.

In addition, in the Fischer-Tropsch synthesis, friable catalyst particles suspended in a catalyst bed, particularly a fluidized bed, have the disadvantage of being compelled against the wall of the reaction vessel, broken into smaller catalyst particles, and entrained by gas passing through the reaction vessel. This catalyst attrition results in the necessity of replacing catalyst.

Notwithstanding the foregoing patents and teachings, there remains a need for a continuous Fischer-Tropsch synthesis by which the production of certain hydrocarbons can be maximized and controlled.

The present invention overcomes the deficiencies of the prior art.

### SUMMARY OF THE INVENTION

The present invention provides an apparatus and method for producing hydrocarbons according to the Fischer-Tropsch synthesis. Particularly, the present invention provides a catalytic distillation reactor and its use for Fischer-Tropsch synthesis. In a preferred catalytic distillation reactor a single apparatus simultaneously achieves both the reaction of hydrocarbons from synthesis gas starting materials and the separation of the hydrocarbon product into various product streams.

A preferred embodiment includes a catalytic distillation reactor in which synthesis gas flows through one or more reaction chambers, which may include beds of catalyst material, such as one or more supported catalysts, including without limitation, cobalt, ruthenium, iron based catalysts, or other Fischer-Tropsch catalysts as are well known in the art, at conversion-producing conditions of temperature and pressure. The Fischer-Tropsch reactions occur in the reaction chambers. Heavier hydrocarbon products such as waxes fall to the bottom of the column reactor, where they can be removed, and progressively lighter gaseous hydrocarbon products flow to the upper regions of the column reactor. At one or more of various points on the column reactor, hydrocarbon products may be removed from the reactor. Hydrocarbons can be also condensed and refluxed into the reactor at any of one or more various points.

An additional aspect of a preferred embodiment of the invention is that it allows for greater control of the Fischer-Tropsch product selectivity. As further explained herein, in a preferred embodiment, the conversion of synthesis gas feed to end hydrocarbon products occurs in a series of successive reaction chambers. The degree of conversion may be optimized by controlling the amount and type of catalyst material in each reaction chamber, as well as the reaction conditions in each reaction chamber, including the temperature, pressure, and the amount and concentration of reactants and products in the reaction chamber.

A further aspect of a preferred embodiment of the invention is that it allows for optimization of the hydrocarbon products produced. A typical Fischer-Tropsch process produces a range of hydrocarbon products including waxes, diesel, gasoline, LPG (liquefied petroleum gas) and gases such as methane, ethane, propane, and butane. A preferred embodiment of the present invention allows the more desirable product streams, such as kerosene and diesel, to be maximized, while the other product streams are minimized. Selectivity control is also enhanced since the heavy material will disengage from the catalyst and fall to the bottom. The bottom temperature will not boil the heaviest hydrocarbons. The light hydrocarbons are therefore in contact with the catalyst for a longer time.

Another aspect of a preferred embodiment of the present invention is that it allows for the removal of water produced during Fischer-Tropsch synthesis from the desired hydrocarbon products. Water removal has the advantage of reducing the H₂O partial pressure in reactor sections, thus assisting with the Fischer-Tropsch synthesis. In addition, water removal increases the lifespan of a Fischer-Tropsch catalyst.

Still another aspect of a preferred embodiment of the present invention is that it permits the removal of paraffins produced during the Fischer-Tropsch synthesis. Paraffins, which do not generally react further under Fischer-Tropsch conditions, may be removed at one or more points of the catalytic distillation reactor. Removing paraffins has the advantage of decreasing the paraffins' partial pressure in various sections of the reactor, and thereby assisting in the Fischer-Tropsch synthesis.

A preferred embodiment of the present invention provides a still further advantage of providing a solution to the limitations of internal heat exchange equipment. Hot fluids may be pumped from one or more regions of the catalytic distillation reactor. These heated fluids are directed to one or more heat exchangers that are positioned outside of the catalytic distillation reactor. While passing through the heat exchanger, the fluids are cooled. Once the fluids are cooled as desired, they are returned to the catalytic distillation reactor through return lines where they can continue the process of reaction and separation. By providing for a heat exchange process outside the reaction vessel itself, the limitations associated with internal heat exchange means are avoided.

One aspect of the present invention features a catalytic distillation reactor that includes a reaction vessel, a plurality of distillation zones inside the reaction vessel that include a reaction chamber, and a plurality of catalyst materials disposed in the reaction chambers. Further, at least one of the catalyst materials includes a support that serves as a packing material. The support may be in the form of a monolith, preferably a honeycomb monolith. The honeycomb monolith may include from about 20 to about 30 channels/inch. Likewise, the honeycomb monolith may include from about 400 to about 900 channels/in². The honeycomb monolith may include a channel having a portion an axis disposed at a nonzero angle with respect to the axis of at least one of said reaction chambers, said at least one chamber containing said honeycomb monolith. The oriented portion may extend to include all of the channel. Alternately, the monolith may be in the form of a foam monolith. The catalyst material may further include a metal catalyst catalytically active for a Fischer-Tropsch reaction. The metal catalyst may be selected from the group consisting of iron and cobalt. The distillation zones may be configured for optimal separation of a desired reaction product. The reaction product a Fischer-Tropsch reaction product. The reactor may be any of a fixed bed reactor, a thin film reactor, a small diameter bubble column reactor, a counter current trickle-flow reactor, and a reactor comprising a supercritical carrier fluid.

In another aspect of the present invention, it features a method for the Fischer-Tropsch synthesis of hydrocarbons that includes injecting reactants into the above described catalytic distillation reactor and removing hydrocarbon products from said catalytic distillation reactor.

In still another aspect of the present invention, it features a catalytic distillation reactor that includes a reaction vessel including a separation/reaction chamber, a packing material disposed in the chamber, and a catalyst supported on the packing material. The catalyst and support preferably form a Fischer-Tropsch catalyst material. The support preferably is in the form of a honeycomb monolith. The reaction vessel may further include a product line, preferably that draws a petroleum product. The petroleum product may be any of diesel fuel, kerosene, jet fuel, gasoline, LPG, methane, ethane, propane, and butane. The reactor may be any of a fixed bed reactor, a thin film reactor, a small diameter bubble column reactor, a counter current trickle-flow reactor, and a reactor comprising a supercritical carrier fluid.

In yet still another aspect of the present invention, it features catalytic distillation reactor for Fischer-Tropsch synthesis of hydrocarbons that includes a reaction vessel and a plurality of trays, disposed inside the reaction vessel at a plurality of vertical locations so as to divide the reaction vessel into a plurality of reaction chambers. Further, the catalytic distillation reactor includes at least one catalyst material positioned above at least one of said trays that includes a support in the form of a honeycomb monolith. Still further, the reactor includes a plurality of feedlines entering the reaction vessel that are positioned so as to deposit materials in one or more of said reaction chambers and a plurality of product lines that are positioned so as to remove materials from one or more of the reaction chambers. Additionally, the reactor includes an exchanger for transferring heat, the exchanger being external to the vessel.

Thus, the present invention comprises a combination of features and advantages that enable it to overcome various problems of Fischer-Tropsch synthesis. The various characteristics described above, as well as other features, objects, and advantages, will be readily apparent to those skilled in the art upon reading the following detailed description of the preferred embodiments of the invention, and by referring to the accompanying drawings.

Other objects and advantages of the invention will appear from the following description. For a better understanding of this invention, reference is made to the detailed description thereof which follows, taken together with the subjoined claims.

### BRIEF DESCRIPTION OF THE DRAWINGS

For a detailed description of a preferred embodiment of the present invention, reference will now be made to the accompanying drawings, which form a part of the specification, and wherein:

FIG. 1 is a schematic view of an embodiment of a catalytic distillation reactor constructed in accordance with the present invention;

FIG. 2 is a schematic view of an alternative embodiment of the present reaction vessel having different diameters at different vertical positions on the reaction vessel;

FIG. 3 is a schematic view of a second alternative embodiment of the present reaction vessel configured such that one reaction chamber contains no catalyst material;

FIG. 4 is a schematic view of a third alternative embodiment of the present reaction vessel having external heat exchange lines and heat exchangers;

FIG. 5 is a schematic view of a fourth alternative embodiment of the present reaction vessel having external heat exchange lines, heat exchangers, water separation stages, paraffin separation stages and return lines;

FIG. 6 is a view of a fifth embodiment of the present reaction vessel having catalyst beds which may be of varying thickness;

FIG. 7 is a view of a plurality of the present reaction vessels running in parallel and surrounded by a common cooling medium;

FIG. 8 is a view of a plurality of the present reaction vessels running in parallel and surrounded by individual cooling units.

FIG. 9 is a schematic view of an embodiment of the present reaction vessel having monolithic catalyst materials.

FIG. 10 is a schematic view of a monolithic catalyst material serving in a thin film reactor according to an alternative embodiment of the present reaction vessel.

FIG. 11 is a schematic view of a monolithic catalyst material serving in a small diameter bubble column reactor according to another embodiment of the present reaction vessel.

FIG. 12 is a schematic view of an arrangement of monolithic catalyst materials according to still another embodiment of the present reaction vessel;

FIG. 13 is a series of plots showing distributions of hydrocarbon weights with carbon number for hydrocarbons produced in Run 1 (13a) and Run 2 (13b) Example 1.

### DETAILED DESCRIPTION OF A PREFERRED EMBODIMENT

As described in detail below, a preferred embodiment of the present invention includes a reaction vessel that includes a catalyst for driving the reaction and an apparatus and method for continuously separating and recovering the reaction products. The vessel also allows for the continuous feed of various feedstocks into the vessel and for the continuous removal of heat from the vessel. The catalyst is preferably supported on a monolith, more preferably a honeycomb monolith, such that the catalyst material serves as both a packing and a column for the reaction vessel.

Vessel

Referring initially to FIG. 1, a preferred embodiment of the present catalytic distillation reactor 10 includes a reaction vessel 12, which generally follows the shape of any of the various distillation columns and mass transfer reactors well known in the art. According to one preferred embodiment, the reactor is generally tubular or cylindrical. The interior of reaction vessel 12 is substantially in the form of a capped hollow tube. During operation, the reaction vessel 12 typically rests in an upright position. Reaction vessel 12 may also conform to other shapes and configurations such as square, oval or rectilinear. Reaction vessel 12 may preferably be formed of multiple cylindrical sections. In this configuration, each of the multiple cylindrical sections includes a flange at each end so that the sections can be bolted together to form the overall reaction vessel 12 of FIG. 1. Caps 13 and 14, disposed on the upper and lower end of the reaction vessel, respectively, act to seal the reaction vessel 12 so that it can be pressurized to conversion-promoting conditions. Reaction vessel 12 is typically constructed of any material capable of withstanding the temperatures and pressures encountered in Fischer-Tropsch synthesis. In one preferred embodiment, reaction vessel 12 is constructed of carbon steel.

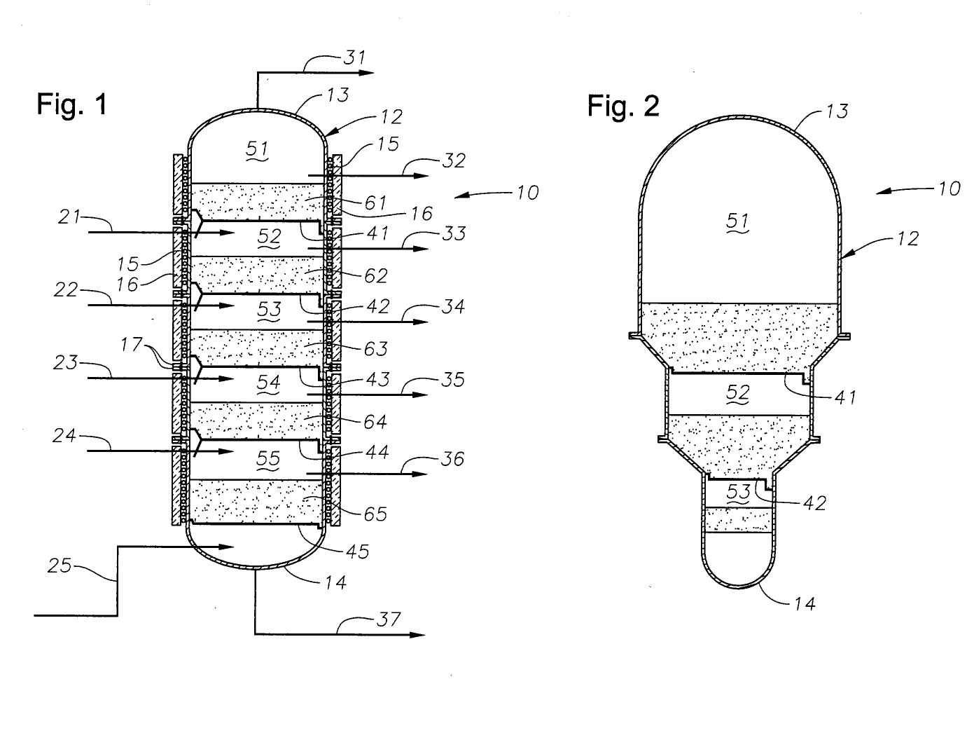

In an alternative embodiment shown in FIG. 2, the diameter of reaction vessel 12 varies with vertical position. The reaction vessel shown in FIG. 2 has three horizontal sections with different diameters. As is well known in the art, a distillation column may be designed to have an upper region having a larger diameter than a lower region of the distillation column. This is done to facilitate the expansion and flow of lighter gases in the upper region of the column. In FIG. 2, three reaction zones 51, 52, 53 are shown, although it will be understood that more or fewer zones could be created, having different or similar dimensions. Because the reactors may be shapes other than cylindrical, as used herein, the word “diameter” will mean, without limitation, the traditional diameter of a circle as well as any analogous measurements for different shapes (e.g., the diagonal length of a square).

Positioned inside of reaction vessel 12 of FIG. 1 are a plurality of trays 41, 42, 43, 44, and 45, which define the lower boundaries of a plurality of reaction chambers 51, 52, 53, 54, and 55, respectively. In a preferred embodiment, trays 41, 42, 43, 44, and 45 conform substantially to the interior dimensions of said reaction vessel. It is also preferred that each tray lie in a substantially horizontal position within reaction vessel 12, although it is contemplated that the trays can be inclined. Trays 41, 42, 43, 44, and 45 can be constructed of any material suitable for use in a chemical reactor, including carbon steel. Trays 41, 42, 43, 44, and 45 are typically fastened to the interior of the reaction vessel 12 by conventional mechanical means, such as, but not limited to, bolts, welds, screws, pins, hangers, and interlocking fittings.

Although as shown in FIG. 1 the positions of the individual trays 41, 42, 43, 44, and 45 correspond to the ends of the vessel segments, it will be understood that trays 41, 42, 43, 44, and 45 can be set at varying and adjustable vertical positions within reaction vessel 12. The reaction chambers 51-55 represent individual regions within the reaction vessel 12 in which simultaneous operations of reaction and physical separation take place. It is not necessary that the reaction chambers 51, 52, 53, 54, and 55 be equal in height. Similarly, other embodiments may have a different number of reaction chambers than that shown and the reaction chambers may each have different configurations as explained below.

Passageways through or around trays 51-55 may be provided by a series of bubble caps, downcomers, weirs, filters, sieves, sintered metal sieves, and/or other standard items that are typically used for mass transfer of gaseous and liquid materials in a distillation column. Other materials commonly used in distillation columns to assist in the distillation process may be used in reaction vessel 12 as a matter of engineering design choice and optimization. Some examples of such materials are baffles, plastic or metal saddles, and rings.

Furthermore, according to the present invention, each tray may have any one of several distinct configurations. For example, one or more trays may consist of a metal tray and bubble caps. Other trays may include a filter or sieve structure. Not every tray needs to have the same configuration and, in one preferred embodiment, each tray has a configuration that has been optimized for the particular reaction/separation combination to be performed on that tray.

Positioned above trays 41-45 are catalytic materials 61, 62, 63, 64, and 65, respectively. The catalytic materials preferably comprise all of the necessary components of a Fischer-Tropsch catalyst or catalyst system. Thus, active catalyst components such as catalytically active metals for Fischer-Tropsch synthesis and their precursor and derivative compounds, are included within the definition of “catalytic material” as used herein. Support materials such as aluminas, silicas, and other catalyst support materials, as are well known in the art, are likewise included within the definition of “catalytic material” as used herein. Promoters, activators, and other materials that facilitate catalysis are also included within the definition of “catalytic material.”

While catalytic materials 61-65 are shown occupying less than all of the volume of their respective chambers, the volume of the catalytic materials may be increased or decreased. For example, in some embodiments, the catalytic material fills each chamber. It is further contemplated that, in some configurations, the catalyst may be supported on a packing material or other support that is also capable of functioning as a distillation packing, so as to enhance separation. Alternatively, non-catalytic distillation packing or the like (not shown), can be used in conjunction with the catalytic material(s) 61-65. In this case, the distillation packing can be used above one or more portions of catalytic material, or can be mixed with the catalytic material. Additionally and alternatively, the distillation packing, whether catalytic or non-catalytic, may be dump packed or structurally packed.

A plurality of feed lines 21, 22, 23, and 24 are preferably provided for feeding the desired gases into reaction vessel 12. Although four feed lines are shown, any number of feed lines, more or fewer than four, may be used. Preferably, each of the feed lines 21-24 enters the reaction vessel 12 into one of the reaction chambers 52-55, respectively, as shown in FIG. 1. In other embodiments, feed lines 21, 22, 23, and 24 may be positioned according to a variety of configurations so as to achieve certain desired effects. For example, all feed lines may enter the reaction vessel in one reaction chamber. Compressors, heaters, and the like (not shown) can be provided on feed lines 21-24, so that the feed materials can be preheated and pressurized if desired. For example, it may be desired to preheat and pressurize the feed materials such that they enter the reactor at conditions compatible with those of the reaction vessel 12 at their point of entry.

According to a preferred embodiment, the reaction/separation products exit reaction vessel 12 through on or more of product lines 31, 32, 33, 34, 35, 36, and 37. The compositions of the various products passing through these product lines will vary depending on operating parameters, as described below.

Still referring to FIG. 1, a plurality of heating coils 15 are preferably positioned around reaction vessel 12. Heating coils 15 may be selected from among the heating coils commonly used in the art for reactors and distillation columns. Insulation 16 is positioned around heating coils 15 and is preferably placed around the exterior of reaction vessel 12 and coils 15 as shown in FIG. 1. A separate heating coil 15 is preferably disposed around each individual reaction chamber 51, 52, 53, 54, and 55 and each coil 15 is preferably individually controlled so as to maintain each of the reaction chambers at a specific desired temperature.

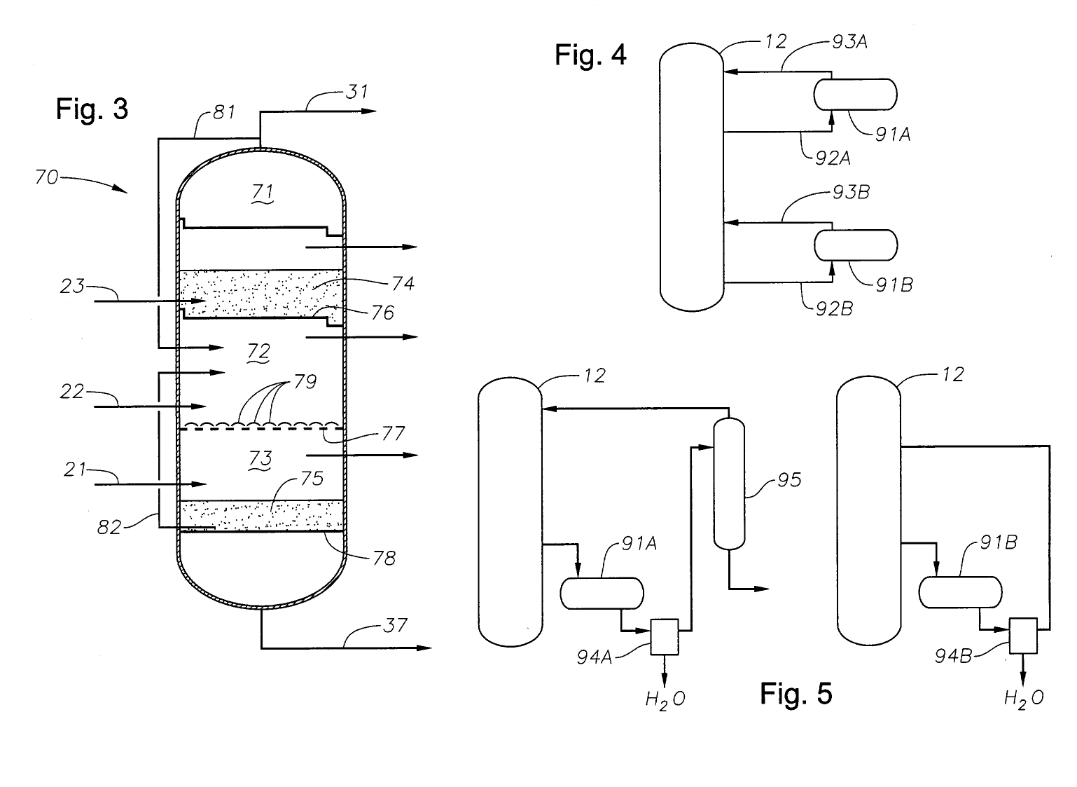

In the embodiment shown in FIG. 1, a catalytic material 61-65 is present in each of the reaction chambers 51-55. In other embodiments of the present invention, however, one or more reaction chambers 51-55 may have no catalyst material present. By way of illustration and not limitation, in such an embodiment, any tray and its associated reaction chamber that does not contain catalytic material, would be configured to act essentially as a stage of a distillation column. FIG. 3 shows a reaction vessel 70 configured so that one reaction chamber 72 does not contain a catalyst material. As shown in FIG. 3, Fischer-Tropsch synthesis occurs in a lower reaction chamber 73 of the reaction vessel 70. The conditions present in lower reaction chamber 73 (the temperature, pressure, catalyst material, etc.) are chosen to optimize Fischer-Tropsch synthesis consistent with the relative position of reaction chamber 73 in the reaction vessel 70. Catalyst material 75 in reaction chamber 73 rests on tray 78 or is otherwise supported. Lighter hydrocarbons move upward from reaction chamber 73. These hydrocarbons may be moved upward through a series of pure distillation stages that contain no catalyst material, such as reaction chamber 72. Reaction chamber 72, defined by trays 76 and 77, contains no catalyst material, and distillation in reaction chamber 72 is achieved through bubble caps 79 that are positioned on tray 77. Once the lighter hydrocarbons reach an upper region of reaction vessel 70, the hydrocarbons encounter a new set of conditions that promote Fischer-Tropsch synthesis in reaction chamber 71, which contains catalyst material 74. Reaction chamber 71 has conditions chosen to optimize Fischer-Tropsch synthesis in the relative position of upper reaction chamber 71. While the lighter hydrocarbons migrate to upper regions of the reaction vessel 70, heavier hydrocarbons move in the opposite direction to the lower areas of the reaction vessel 70. Thus, the individual reaction chambers in the present device can be uniquely tailored to promote Fischer-Tropsch synthesis for the kinds of hydrocarbons that predominate in each such reaction chamber.

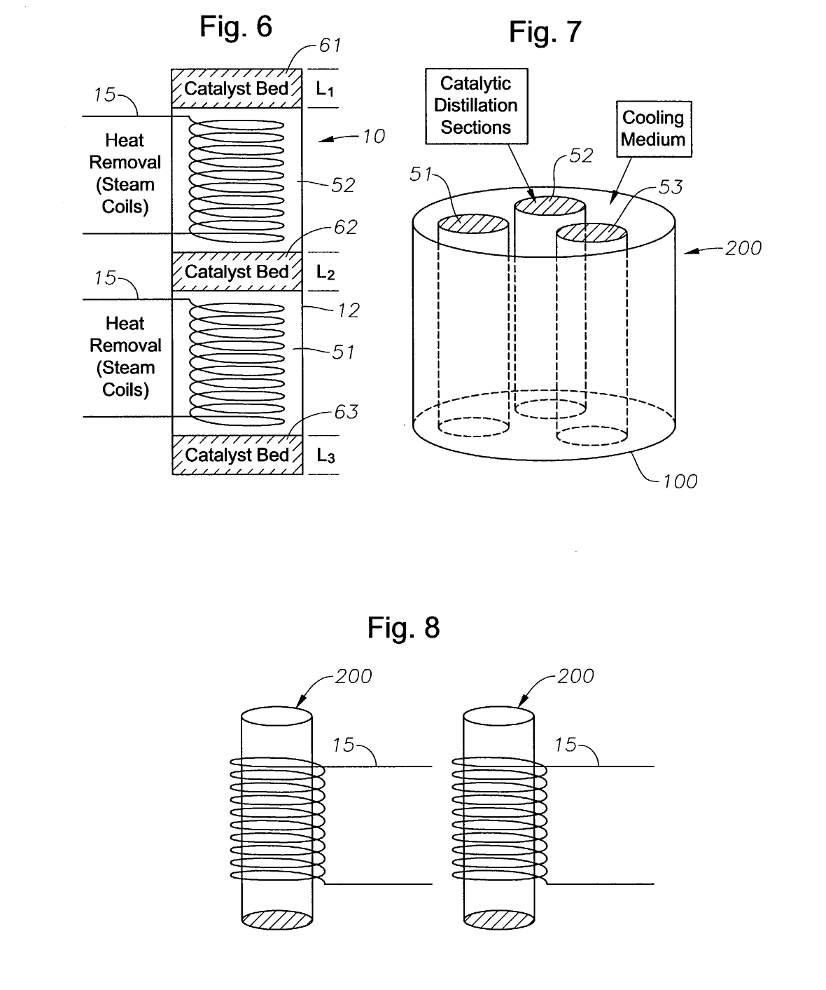

Referring now to FIG. 6, a catalytic distillation reactor 10 is provided in which layers of catalyst material 61, 62, 63 of varying thickness are staged between distillation/heat removal chambers 51, 52. The thickness of the catalyst materials 61, 62, 63 may be varied such as to control the reaction and the temperature rise within the distillation/heat removal chambers 51, 52. Any excess heat would be removed by the heat removal coils 15, which may consist of steam coils or any other acceptable heat removal system which is well known in the art. The heat removed from the chambers may then be disposed of by any acceptable means (e.g., inter-process heat exchange (not shown)).

Referring now to FIG. 7, a catalytic distillation reactor segment is provided having a plurality of reaction chambers 51, 52, 53 running in parallel inside of an outer shell 100. Within the outer shell 100 and external to the reaction chambers 51, 52, 53 is provided a cooling medium which may be any acceptable cooling medium as is well known in the art (e.g., steam). Preferably, the distillation reactor segment 200 is adapted to be stacked on other distillation reactor segments and would contain mechanisms for product removal (such as those shown in FIG. 1, reference nos. 31-37), liquid redistribution (such as those shown in FIG. 3, reference nos. 81 and 82), and gas/liquid feed streams (such as those shown in FIG. 1, reference nos. 21-24).

Referring now to FIG. 8, a plurality of catalytic distillation reactor segments 200 are run in parallel, each with separate external heat removal units 15 for temperature control. Preferably, the distillation reactor segments 200 are adapted to be stacked on other distillation reactor segments and would contain mechanisms for product removal (such as those shown in FIG. 1, reference nos. 31-37), liquid redistribution (such as those shown in FIG. 3, reference nos. 81 and 82), and gas/liquid feed streams (such as those shown in FIG. 1, reference nos. 21-24).

Other common features of distillation columns may be incorporated into the design of the present reaction vessel. These include manholes or manways, which provide access to the interior and facilitate cleaning of the vessel, and inspection ports or windows to permit visual inspection of the interior of the reaction vessel while in use. It is also common practice to provide gangways or ladders on the exterior of the catalytic distillation reactor to permit physical access to all parts of the catalytic distillation reactor.

Catalysts

Catalytic materials 61-65 may be present in different amounts, concentrations, forms and configurations in each of the reaction chambers 51-55. The presence of any mechanical apparatus necessary to position the catalyst material within the column will be understood and will not be further recited herein. Such a mechanical apparatus may include, by way of illustrative example only, catalyst containers, holders, baskets, racks, or nets. Similarly, any suitable configuration may be employed for catalytic materials 61-65. For example, fixed bed, fluidized bed, slurry phase, slurry bubble column, or ebulliating bed systems, among others, may be used. Accordingly, the size and physical form of the catalyst materials 61-65 may vary depending on the reaction chamber in which they are to be used.

The catalytic distillation reactor of the preferred embodiment is preferably used with catalysts active for Fischer-Tropsch synthesis. However, there is no particular catalyst type that must be used in the reaction vessel; indeed, reaction vessel 12 may be used with any of the Fischer-Tropsch catalysts now commonly used in Fischer-Tropsch synthesis reactors, or with other types of catalysts. In a similar vein, the preferred embodiment may operate with any physical form of the catalyst, or as it is sometimes called, the catalyst system. In other words the catalytic distillation reactor will function with packed bed, slurry bed, or other types of catalysts.

Monolithic Catalyst Support

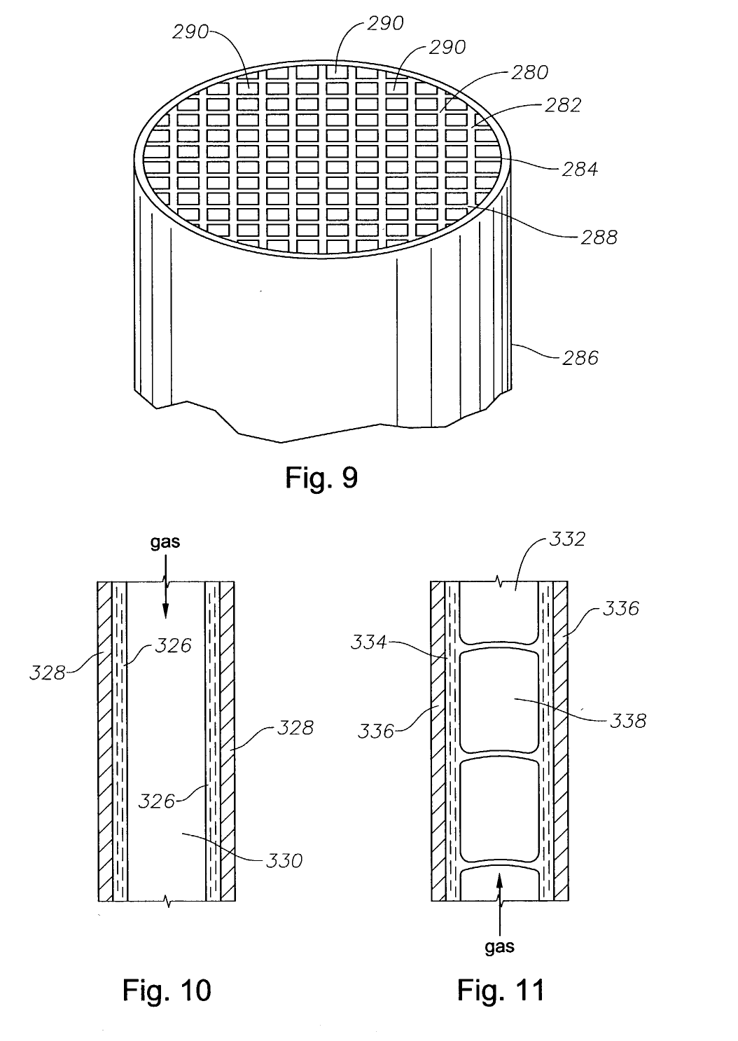

Referring now to FIG. 9, in a configuration of catalyst materials contemplated as suitable for use with the present reaction vessel, catalyst materials 280 include a support 282 in the form of a monolith 284. Further, support 282 functions as packing material for distillation. Reaction chamber 286 may contain a single monolith or a plurality of monoliths, for example stacked one above another. It is preferred that each support 282 have a cross-sectional diameter slightly less that the inner diameter of the reaction chamber, so that support 282 substantially fills the cross-section of reaction chamber 286. Monolithic supports are known in the art and include, for example honeycomb supports and foam supports, as described for example in as described in “Structured Catalysts and Reactors”, edited by A. Cybulski and J. A. Moulijn, (Marcel Dekker, Inc., 1998), pp. 24-25 and pp. 164-169, hereby incorporated herein by reference. Monolithic catalysts are exemplary of structured catalysts.

Referring still to FIG. 9, a preferred monolith is a honeycomb monolith 288. Honeycomb monolith 288 has a structure that includes longitudinal channels 290. Channels 290 are shown in FIG. 9 with a square cross-section. Alternatively, as is known in the art, channels 290 may have any suitably cross-section shape, including triangular, hexagonal, and the like. The cross-sectional perimeter and area of channels 90 may be varied, such as depending on the type of reaction chamber or configuration of catalyst materials in a bed. Honeycomb monoliths are known having channel sizes at least up to about 1000 channels per inch (cpi). A particularly preferred form of the honeycomb monolith, particularly for use in a fixed bed reactor configuration, is a honeycomb having from about 20 to about 30 channels per inch, more preferably from about 400 to about 900 channels/in².

Referring now to FIG. 10, the orientation of a channel 296 relative to the axis 298 of reaction chamber 100 may be varied. Honeycomb monolith 302 includes channels 304 arrayed axially in a straight configuration within a reaction chamber 300. In contrast, honeycomb monoliths 306, 307 includes channels 308, 309 oriented at an angle with respect to axis 298. In particular, channels 308 are oriented at a non-zero angle α with respect to axis 298 and channels 309 are oriented at a non-zero angle β with respect to axis 298. Thus, the angles of channels in stacked honeycombs may vary within a reaction chamber. The adjacent openings 310, 312 of channels 308, 309, respectively, may be substantially aligned. This configuration is expected facilitate passage of liquids and gases between channels 308 and 309. Likewise, it is preferred that the adjacent openings, or the projections thereof transverse to axis 298, of channels in any stacked honeycombs may be substantially aligned with respect to axis 298. Although three stacked monoliths are depicted in FIG. 10, it is understood that a reaction chamber may contain one or more monoliths, each of which may have a slanted or straight orientation of channels. Further, although channels in adjacent honeycombs are depicted in FIG. 10 in an aligned configuration, it is contemplate that the channels may be in an offset configuration.

The pathway through a channel of a honeycomb monolith is typically referred to by those in the art in terms of tortuosity. The term tortuosity is calculated as the ratio of the length of the path taken by the fluidized stream flowing through the substrate divided by the length of the shortest straight line path through the substrate. Thus, a straight channel pathway, such as shown in FIG. 10, for monolith 302 has a tortuosity of 1.0. In contrast, the stack of monoliths 302, 306, 307, as a whole, has a tortuosity of greater than 1.0.

It will be appreciated that a honeycomb monolith according to another preferred embodiment of the present invention may have a tortuosity greater than 1.0, for example by including channels that are not straight.

A configuration of a catalyst materials that includes one or more monoliths having channels having portions at an angle to the axis of the reaction chamber has the advantages of promoting mixing, promoting vapor-liquid interaction, and tending to reduce channeling. Channeling, as used herein, refers to the separate movement of liquids downward in one or more channels and gases upward through one or more other channels.

The use of the honeycomb monolith as a support is particularly useful for a fixed bed configuration of catalyst. As is known in the art, the void space and area may be varied depending on the application. Referring again to FIG. 9, a channels 290 provide a total cross-sectional void area that is selected preferably according to the cross-sectional area of reaction chamber 286. A total cross-sectional void area that is too small as compared to the cross-sectional chamber area has the disadvantage of tending to result in low reactive surface area. A total cross-sectional void area that is too large as compared to the cross-sectional chamber area has the disadvantage of tending to result in flooding, poor reactant catalyst contact, high pressure drop, and other undesired aspects. Thus, the total cross-sectional void area of reaction monolith 284 is preferably optimized with respect to the cross-sectional chamber area.

Referring now to FIG. 11, according to an alternative preferred embodiment, a honeycomb monolith may be used as the catalyst support for a thin film reactor. In a thin film catalyst bed, liquid hydrocarbons containing dissolved hydrogen and carbon monoxide form a thin film 326 on the wall 328 of a honeycomb channel 330. A thin film reactor has the advantage of alleviating the mass transfer of gas through the hydrocarbon fluids to the catalyst. A thin film reactor forces the gas through channel 330, which acts as a capillary, thus squeezing the reaction medium into a thin film against wall 326. The catalyst may include a metal supported on a honeycomb monolith, such as alumina, preferably set in a vertical orientation.

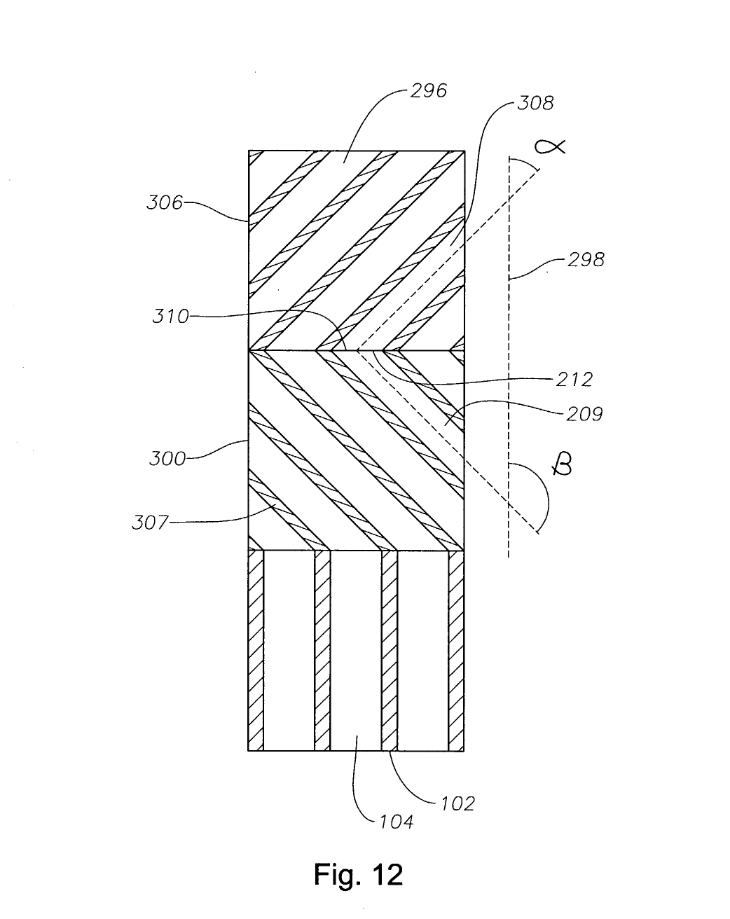

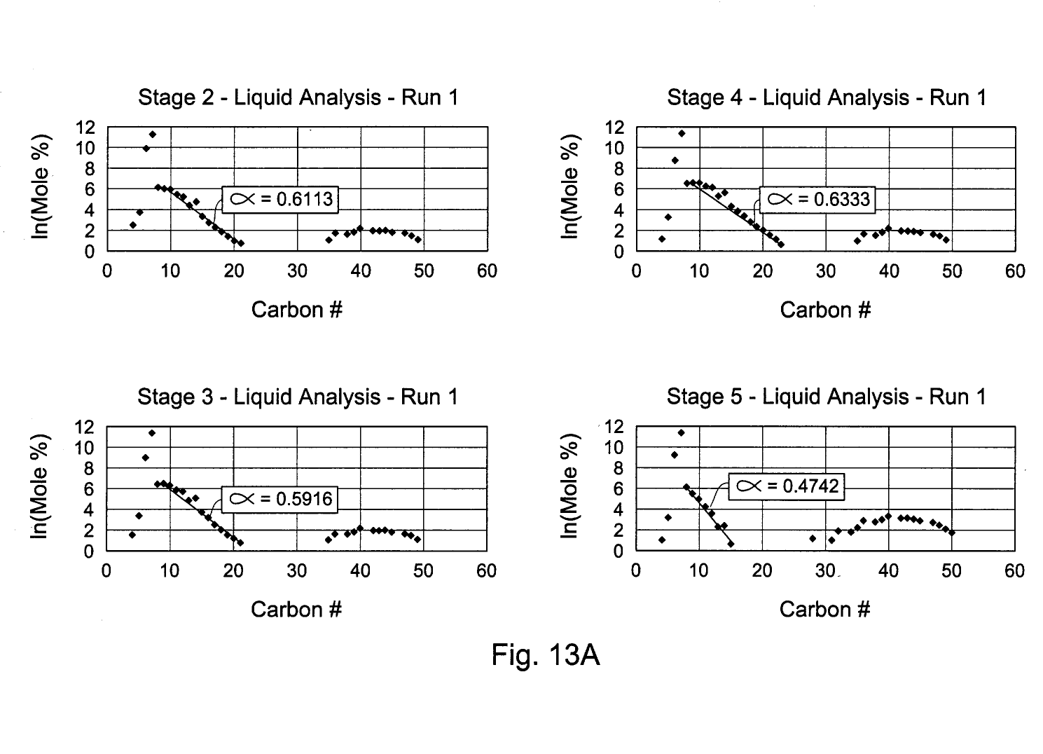

Referring now to FIG. 12, according to still another preferred embodiment, a honeycomb monolith may be used as a catalyst support in a small diameter bubble column. It is expected that the flow inside the channels 332 of the honeycomb will be plug flow. Further, as for use with a thin film reaction, hydrocarbon fluid containing dissolved hydrogen and carbon monoxide would form a thin film 334 on the wall 336 of a honeycomb channel 332. Thus, in effect, this reactor configuration would resemble the film reactor configuration shown in FIG. 12, but with gas flow being up rather than down. Synthesis gas is forced from the bottom to the top of the reactor, through the hydrocarbon fluids. As synthesis gas bubbles 338 pass up the catalyst column, the hydrocarbon fluids form thin film 334 against wall 336.

According to yet another preferred embodiment, a honeycomb monolith may be used as a catalyst support in a counter current trickle-flow reactor. The configuration of such a trickle bed reactor may be varied depending on the application. It is preferred that the monolith be configured so that it may be used in conjunction with reflux of a reaction product through the trickle bed.

It will be understood that the orientation of the honeycomb monolith may vary with the application. For example, a honeycomb support for use with a reactor that uses a supercritical fluid as a carrier fluid for synthesis gas may configured either vertically or horizontally, due to the liquid-like behavior of the carrier fluid. A supercritical fluid as the carrier fluid has the advantage of acting as a solvent to wash wax and heavy hydrocarbons from the surface of the catalyst material, thus increasing surface area of the catalyst material that is available for reaction. Further, the use of a supercritical carrier fluid has the advantage of allowing a higher concentration of synthesis gas than in a non-supercritical hydrocarbon carrier fluid, thus further improving contact of the synthesis gas with the catalyst material.

It will be understood that the form of the monolith support, such as monolith 282 in FIG. 9, may be varied. For example, in still yet another preferred embodiment, a support 282 is in the form of a foam monolith (not shown). The pore size may be varied depending on the desired void size. A foam monolith has the advantage of tending to reduce channeling. Further, a foam monolith has the advantage of tending to reduce the pressure drop.

A preferred method of preparing a honeycomb monolith is extrusion. Honeycomb monolithic substrates are typically constructed from an extruded ceramic material, usually as a cylinder or disk, although the any shape can be extruded as necessary for a certain application. Alternatively, a formed metallic foil monolithic structure may also be used.

An advantage of the use of a honeycomb monolith support is that the catalyst material serves as packing material for a distillation/reaction chamber. Further, a monolith catalyst support has the advantage of reducing catalyst attrition.

Active Catalyst Components

According to one preferred embodiment, the active catalyst components present in the catalyst materials include any metal known to promote Fischer-Tropsch synthesis. By way of illustration and not limitation, these active metals comprise Mn, Fe, Co, Ni, Tc, Ru, Rh, Pd, Re, Os, Lr, Pt, and combinations thereof, among others.

Active catalyst components used in the catalyst material of the preferred embodiment may be carried or supported on any suitable support material, including but not limited to materials selected from the group including silica, titania, titania/alumina, zirconia, alumina, aluminum fluoride, and fluorided alumina, aluminum borate, and borated alumina, silica, titania, titania/alumina, and combinations thereof. Other support materials, well known in the art, may also be used. Aluminum fluoride supports are defined as at least one aluminum fluoride (e.g., alpha-AlF₃, beta-AlF₃, delta-AlF₃, eta-AlF₃, gamma-AlF₃, kappa-AlF₃ and/or theta-AlF₃). Preferred supports include silica, alumina and aluminum fluoride. Preferred aluminum fluoride supports are aluminum fluorides that are primarily alpha-AlF₃ and/or beta-AlF₃.

The support material, as disclosed above, may be in the form of a honeycomb. When the support is in the form of a honeycomb monolith, a preferred monolith includes a base containing a conventional honeycomb material, such as cordierite (2MgO-5SiO₂-2Al₂O₃), commonly uses for automobile catalytic converters, mullite, (3Al₂O₃-2SiO₂), and the like. The monolith preferably further includes a coating carried on the base, the coating containing one of the above-mentioned support materials. Thus, a method of making a catalyst may include coating a honeycomb base with a material selected any of the above-mentional support materials. The coating may be performed, for example, by any suitably chemical deposition technique.

Other catalyst materials may be used. For example, U.S. Pat. Nos. 4,619,910; 4,670,472; and 4,681,867, hereby incorporated herein by reference, describe a series of catalysts for use in a slurry Fischer-Tropsch process in which synthesis gas is selectively converted to higher hydrocarbons of relatively narrow carbon number range. Reactions of the catalyst with air and water and calcination are specifically avoided in the catalyst preparation procedure. The catalysts are activated in a fixed-bed reactor by reaction with CO+H₂ prior to slurrying in the oil phase in the absence of air.

Further, U.S. Pat. No. 4,477,595 discloses ruthenium on titania as a hydrocarbon synthesis catalyst for the production of C₅ to C₄₀ hydrocarbons, with a majority of paraffins in the C₅ to C₂₀ range. U.S. Pat. No. 4,542,122 discloses a cobalt or cobalt-thoria on titania having a preferred ratio of rutile to anatase as a hydrocarbon synthesis catalyst. U.S. Pat. No. 4,088,671 discloses a cobalt-ruthenium catalyst where the support can be titania but preferably is alumina for economic reasons. U.S. Pat. No. 4,413,064 discloses an alumina supported catalyst having cobalt, ruthenium and a Group 3 or Group 4 metal oxide, e.g., thoria. European Patent 142,887 discloses a silica supported cobalt catalyst together with zirconium, titanium, ruthenium and/or chromium. The patents identified in this paragraph are hereby incorporated herein by reference.

Aluminas that have been treated with fluosilicic acid (H₂SiF₆) such as those described in European Patent Application No. EP 497,436, hereby incorporated herein by reference, can also be used as a support. The disclosed support comprises from about 0.5 to about 10 weight percent of fluorine, from 0.5 to about 5 weight percent of silica and from about 85 to about 99 weight percent of alumina.

It has been found that higher selectivity and productivity catalyst materials may be produced when a promoter is used. The catalyst materials of the present invention may therefore be used with any of the following promoters: Sc, Y, La, Ti, Zr, Hf, Rh, Pd, Os, Ir, Pt, Re, Nb, Cu, Ag, Mn, B, P, and Ta for Co and/or Ru-containing catalysts, and Na, K, Rb, Cs, Mg, Ca, Sr, and Ba for Fe-containing catalysts. The amount of promoter added to the catalyst is typically sufficient to provide a weight ratio of elemental promoter to elemental catalyst metal of from about 0.00005:1 to about 0.5:1.

A preferred form of the desired catalyst material may be prepared by any of the methods known to those skilled in the art. By way of illustration and not limitation, such methods include impregnating the catalytically active compounds or precursors onto a support, extruding one or more catalytically active compounds or precursors together with support material to prepare catalyst extrudates, and/or precipitating the catalytically active compounds or precursors onto a support. Accordingly, as disclosed above, the supported catalysts of the present invention may be used in the form of monoliths, honeycombs, and foams. Alternatively, the supported catalysts for a distillation reactor may be in the form of packed beds powders, particles, pellets, aerogels.

The most preferred method of preparation may vary among those skilled in the art, depending for example on the desired catalyst particle size. Those skilled in the art are able to select the most suitable method for a given set of requirements.

One method of preparing a supported metal catalyst, e.g., a supported cobalt, cobalt/rhenium, or cobalt/rhenium/promoter catalyst is by incipient wetness impregnation of the support with an aqueous solution of a soluble metal salt such as nitrate, acetate, acetylacetonate or the like. Another method of preparing a supported metal catalyst is by a melt impregnation technique, which involves preparing the supported metal catalyst from a molten metal salt. One preferred method is to impregnate the support with a molten metal nitrate, e.g., Co(NO₃)₂.6H₂O. Alternatively, the support can be impregnated with a solution of zero valent metal precursor. One preferred method is to impregnate the support with a solution of zero valent cobalt such as Co₂(CO)₈, Co₄(CO)₁₂ or the like in a suitable organic solvent, e.g., toluene. Suitable rhenium compounds are the common water soluble ones, e.g., rhenium heptoxide (Re₂O₇) and ammonium perrhenate (NH₄ReO₄).

The impregnated support is dried and reduced with hydrogen or a hydrogen containing gas. The hydrogen reduction step may not be necessary if the catalyst is prepared with zero valent cobalt. In another preferred method, the impregnated support is dried, oxidized with air or oxygen and reduced in the presence of hydrogen.

Typically, at least a portion of the metal(s) of the catalytic metal component of the catalyst materials of the present invention is present in a reduced state, i.e., in the metallic state. Therefore, it is normally advantageous to activate the catalyst prior to use by a reduction treatment, in the presence of hydrogen at an elevated temperature. Typically, the catalyst is treated with hydrogen at a temperature in the range of from about 75° C. to about 500° C., for about 0.5 to about 24 hours at a pressure of about 1 to about 75 atm. Pure hydrogen may be used in the reduction treatment, as may a mixture of hydrogen and an inert gas such as nitrogen, or a mixture of hydrogen and other gases as are well known in the art, such as carbon monoxide and carbon dioxide. Reduction with pure hydrogen and reduction with a mixture of hydrogen and carbon monoxide are preferred. The amount of hydrogen may range from about 1% to about 100% by volume.

As stated above, the catalyst material, its physical form, and the concentration of its contents can be optimized in each reaction chamber so as to result in a desired reaction scheme. Indeed, the catalyst material should be selected for each reaction chamber so as to optimize the reactions occurring in said reaction chamber.

The recycling or refluxing of materials is common in distillation columns and is also part of a preferred embodiment. One or more recycle lines or reflux lines may take materials from any reaction chamber and return the materials to the reaction vessel 12 at another point. Preferably, as shown in FIG. 3, a recycle stream 81 will take product from the top reaction chamber and deposit the product at a lower point of the reaction vessel 12. Once returned to a relatively lower position of the reaction vessel 12, the recycled light hydrocarbons that were present in the top reaction chamber 51 may undergo additional Fischer-Tropsch reaction. Also as shown in FIG. 3, reflux line 82 may remove product from a lower reaction chamber and deposit the product in a higher reaction chamber. As will be understood, the recycle and reflux lines 81, 82 may be configured in a number of ways (not shown). A recycle line 81 or reflux line 82 may merge with one or more feed lines 21-24 as one way of returning products to the reaction vessel 12. In another embodiment, a reflux or recycle line may directly reenter the reaction vessel 12 as shown in FIG. 3. Further, the recycle lines 81 may diverge from one or more product lines 31-37, as shown, as a way of returning fluids found in the product lines to the reaction vessel 12. While in a recycle line 81, fluids may undergo heating, cooling, pressurization, or depressurization as needed to place the products in a physical condition appropriate for return to the reaction vessel 12.

Operation

In operation, reactants and other processing materials, if any, preferably enter reaction vessel 12 through feed lines 21, 22, 23, and 24. The reactants typically used to form hydrocarbons according to the Fischer-Tropsch process comprise hydrogen, H₂, and carbon monoxide, CO. Preferably, H₂ and CO are combined and injected into the reaction vessel together as syngas through each of the feed lines 21, 22, 23, and 24. Alternatively, the reactants H₂ and CO may be individually injected into reaction vessel 12 through one or more of the feed lines 21-24. According to one preferred embodiment, one or more H₂/CO feedstock mixtures enter reaction vessel 12 at multiple points through feed lines 21, 22, 23, and 24. The H₂/CO molar ratio may vary for each of feed lines 21, 22, 23, and 24. The molar ratio of hydrogen to carbon monoxide may also be varied between the streams entering reaction chambers 51-55, so as to control the hydrocarbon product distribution. Similarly, other conditions related to feed lines 21, 22, 23, and 24 such as flow rate, temperature, and pressure may vary for each particular feed line.

Nitrogen, which is not a raw material for the Fischer-Tropsch synthesis, is typically used as a purge gas when starting up or shutting down reaction vessel 12 before and after a Fischer-Tropsch synthesis run. Nitrogen, which is an inert element and will not react with the reactants or products typically found during Fischer-Tropsch synthesis, is pumped into the reaction vessel 12. The nitrogen purges vessel 12 by displacing any materials that are in the reaction vessel 12. Nitrogen may be fed into reaction vessel 12 through feed lines 21, 22, 23, and 24, or through any combination of these feed lines. Preferably nitrogen is admitted to reaction vessel 12 through a dedicated nitrogen line 25 as shown in FIG. 1.

The concentrations of feed materials and their injection points, the reaction temperatures and pressures, and the catalyst types and amount of catalyst used in various reaction chambers 51-55 in reaction vessel 12 may all be varied in accordance with the present invention to control the product distribution, conversion, and selectivity. Generally speaking, the product lines disposed in the bottom or lower end of reaction vessel 12 will remove heavier (larger chain hydrocarbons) reaction products. Waxes, for example, will typically exit through bottom product line 37. Progressively lighter hydrocarbons will pass to progressively upper reaction chambers of the reactor vessel 12, where they may be drawn off in one of the upper product lines.

According to one embodiment of the invention, the components of the present column are configured such that the following petroleum products are produced from the reaction vessel. Product line 36, next in order above bottom line 37, drawsprimarily diesel fuel from the reaction vessel 12. Product line 35 drawsprimarily kerosene and product line 34 drawsprimarily jet fuel. Product line 33 drawsprimarily gasoline and product line 32 drawsprimarily LPG. Coming off top line 31 will be gaseous materials, comprising methane, ethane, propane and butane. It should be understood that other embodiments of the present invention may contain a number of product lines different from that just described.

H₂/CO mixtures suitable as a feedstock for conversion to hydrocarbons according to the process of the preferred embodiment can be obtained from light hydrocarbons such as methane by means of steam reforming, partial oxidation, or other processes well known in the art. Preferably the hydrogen is provided by free hydrogen, although some Fischer-Tropsch catalysts have sufficient water gas shift activity to convert some water to hydrogen for use in the Fischer-Tropsch process. It is preferred that the molar ratio of hydrogen to carbon monoxide in the feed be greater than 0.5:1 and preferably from about 0.67:1 to 2.5:1. More preferably, the feed gas stream contains hydrogen and carbon monoxide in a molar ratio of about 2:1. The feed gas may also contain carbon dioxide. The feed gas stream should contain a low concentration of compounds or elements that have a deleterious effect on the catalyst, such as poisons. For example, the feed gas may need to be pre-treated to ensure that it contains low concentrations of sulfur or nitrogen compounds such as hydrogen sulfide, ammonia and carbonyl sulfides.

The Fischer-Tropsch process is typically run in a continuous mode. In this mode, the gas hourly space velocity through a reaction chamber 51-55 typically may range from about 100 volumes/hour/volume catalyst (v/hr/v) to about 10,000 v/hr/v and preferably from about 300 v/hr/v to about 2,000 v/hr/v. The temperature in each reaction chamber 51-55 is typically in the range from about 160° C. to about 300° C. Preferably, each reaction chamber 51-55 is operated at conversion promoting conditions at temperatures from about 190° C. to about 260° C. The reaction chamber pressure is typically in the range of about 80 psig (653 kPa) to about 1000 psig (6994 kPa), preferably, from 80 psig (653 kPa) to about 600 psig (4237 kPa), more preferably, from about 140 psig (1066 kPa) to about 400 psig (2858 kPa), and still most preferably at about 150 psig.

As feed lines 21-24 deposit syngas materials into a given reaction chamber 51-55, simultaneous operations of reaction and separation take place. In the presence of catalyst material, the syngas reactants form hydrocarbons. In each reaction chamber 51-55, the materials present are also subjected to the physical affects caused by the temperature in the reaction chamber. With respect to the hydrocarbons, if the temperature at a given point in the column is above a particular hydrocarbon's boiling point, the molecules of that hydrocarbon will vaporize and become gaseous. Other heavier hydrocarbons will remain as liquids. Gravitational forces will thus act to physically separate the liquids and gases such that the gases will rise to the top of each reaction chamber 51-55 and liquids will remain at the bottom. Thus, in each reaction chamber 51-55, the temperature may be selected so as to control the amount of product that vaporizes or remains liquid.

In operation, liquids formed in one reaction chamber 51-55 will migrate in a downward direction, toward the next lower reaction chamber. Gases formed in one reaction chamber 51-55 will conversely migrate in an upward direction toward the next upper reaction chamber. Once a molecule has migrated from one reaction chamber 51-55 to another reaction chamber 51-55, this molecule will thereupon be subject to further reaction and physical separation according to the configuration present in the new reaction chamber. By a succession of such operations, the catalytic distillation reactor achieves its simultaneous objectives of reaction and separation.

In a reaction chamber configured so as to contain a fixed bed catalyst material, the reaction step occurs in and around the fixed bed in a manner similar to that found in fixed bed Fischer-Tropsch reactors. Fixed bed Fischer-Tropsch catalyst materials typically consist of a monolithic or f support material in which are present the active catalyst components along with the necessary activators and promoters. The support material provides the structure of the catalyst material. In this configuration, the catalyst material does not move. The support material will have interstices and voids through which the reactants and products may migrate into and out of the catalyst material. As stated above, the catalyst bed may be structured so that it does not occupy the entire volume of the reaction zone.

In a reaction chamber configured to contain a fluidized bed of catalyst material, the reaction step takes place throughout the area containing the fluidized bed and in a manner similar to that found in fluidized bed Fischer-Tropsch reactors. A fluidized bed for Fischer-Tropsch synthesis typically consists of solid/gas phases. The catalyst material is present as a solid. The solid catalyst material consists of loosely separated particles that are of a size and mass chosen so that they may be entrained by the gases passing upward through the reaction chamber. In operation, the particles comprising the catalyst material are turbulently mixed by the entraining gases.

In a reaction chamber configured to contain a solid/liquid slurry catalyst material, the reaction will occur in a manner similar to that found in Fischer-Tropsch reactors containing a solid/liquid slurry. A solid/liquid slurry for Fischer-Tropsch synthesis typically consists of solid-liquid phases. The catalyst material is again present as a solid. The solid catalyst material consists of separate particles that are of a size and mass chosen so that they may be slurried by the liquids passing through the reaction chamber. A typical slurry catalyst for Fischer-Tropsch synthesis is described in U.S. Pat. No. 5,348,982, hereby incorporated herein by reference.

Referring now to FIG. 4, a preferred embodiment of the present invention includes heat exchangers 91A, 91B that are external to the column. In this embodiment, heat removal may be achieved by first drawing fluids from reaction vessel 12 through a series of heat exchange lines 92A and 92B. Heat exchange lines 92A and 92B lead from various reaction chambers 51-55 in reaction vessel 12 to one or more heat exchangers 91A and 91B. The heat exchangers are positioned externally from the catalytic distillation reaction vessel 12. Heat exchangers 91A and 91B may be selected from any of a wide variety of heat exchangers commercially available. While in one preferred embodiment, heat exchange lines 92A and 92B are attached to the reaction vessel 12 so as to draw fluids from two of the reaction chambers 51-55 of FIG. 1, other heat exchange line arrangements may be designed. For example, in another embodiment, the number of heat exchange lines may be varied and the heat exchange lines positioned differently. Also by means of illustration and not limitation, heat exchange lines may draw fluids from each reaction chamber 51-55. The heat exchange lines 92A and 92B may draw either liquids or gases from the reaction chambers 51-55. Return lines 93A and 93B, leading from heat exchangers 91A and 91B, direct cooled fluids back into reaction vessel 12. In one preferred embodiment, a return line is linked to each of reaction chambers 51-55, although other embodiments are possible without departing from the scope of the present embodiment. The fluids, that are returned to the reaction vessel 12 in this embodiment, may as shown in FIG. 4 but need not be, returned to the same reaction chamber 51-55 from which they were drawn. The fluids present in the reaction chamber therefore constitute the heat exchange medium in an external heat exchange process. Accordingly, heat exchange equipment internal to the reaction vessel 12 is eliminated or minimized. The removal of heat by external heat exchangers in accordance with the present embodiment thus also allows control of the temperatures in specific reaction chambers 51-55 by removing fluids from a specific reaction chamber 51-55 and returning the cooled fluids to the same reaction chamber. It is therefore possible to control the temperature in individual reaction chambers 51-55 by providing heat exchange equipment for that reaction chamber.

Another embodiment of the invention includes one or more water separation stages. The water separation stage may follow one of several designs. In a preferred embodiment, the water separation stage may be a settling tank wherein water and hydrocarbons settle and separate. Referring to FIG. 5, water separation is achieved by pumping materials into water separation tanks 94A and 94B. When the fluids are condensed to liquid form, the water will physically separate from the liquid hydrocarbons. Once the water has separated, it can be pumped off; the remaining hydrocarbons can then be directed to an appropriate location. The hydrocarbons may either be fed back to the reaction vessel or to a product tank. Water separation may also occur in a flash separation drum. In a preferred embodiment, the water separation occurs in conjunction with the heat removal operation. Referring again to FIG. 5, fluids drawn from reaction vessel 12 are first passed through heat exchangers 91A or 91B. Upon cooling, hot fluids will condense, or partially condense, to liquid form. The fluids next pass to water separation tanks 94A and 94B. It is there that water physically separates from other liquids and can be removed.

In another embodiment (not shown), water separation may also be achieved in conjunction with fluid recycle and reflux. In this embodiment, fluids pumped through the recycle and reflux lines are again passed into a water separation tank. Once the liquids have separated in the water separation tank, the water layer may be pumped off. When recycling fluids from the top of the reaction vessel, the fluids may first pass through a heat exchanger or condenser to cool the fluids. The fluids may then pass into a water separation tank. When refluxing fluids from the bottom of the reaction vessel the fluids may also pass through water separation tanks that will separate out water. Refluxed fluids can themselves be cooled or reheated.

Other embodiments of the invention may also include one or more paraffin separation stages. Referring to FIG. 5, paraffin separation is achieved by pumping materials into a paraffin separator 95. The paraffin separator itself may follow a membrane separation process, a chemical separation process, or be a multi-stage distillation column. The paraffin separator should be designed so as to separate paraffins from olefins. The paraffins, which are no longer reactive in the Fischer-Tropsch synthesis, may then be removed to product storage. The olefins may be returned to the reaction vessel for further Fischer-Tropsch reaction. Paraffin separation may also take place during recycle and reflux operations. In such an embodiment fluids pumped through the recycle and reflux lines will pass through a water separation stage and then a paraffin separation stage. In this manner, reactive olefins can be separated from the non-reactive paraffins. The olefins may be returned to the reaction vessel in the recycle and reflux return lines.

A variety of standard control equipment and measurement devices will assist in the operation of the catalytic distillation reactor. Thermocouples or other temperature measuring devices may be positioned within the reaction vessel 12. Preferably, a plurality of temperature measuring devices may be present at different positions in each reaction chamber such as reaction chambers 51-55 of FIG. 1. In this manner the temperature in each particular reaction chamber 51-55 may be measured and/or monitored. Hot spots, cool spots, temperature spikes and excessive temperature gradients typically should be avoided. Thus, by careful temperature measurement, the proper temperature differential may be maintained between adjacent reaction chambers 51-55 in order to promote the optimum mass transfer between the reaction chambers.

Flow regulators, not shown, typically control the passage of hydrocarbons through feed lines 21-24, product lines 31-37, recycle and reflux lines 81, 82 and heat exchanger lines 92A, 92B, 93A and 93B. Flow regulator equipment may include valves, which may be either manual or automatic. In addition, fluid flows may be measured with standard measuring devices such as manometers and flow meters.

It will be appreciated that, while the above-described catalyst configurations, for example of FIGS. 9-12 have been described with respect to a reaction vessel that may be used as a catalytic distillation reactor, it is contemplated that they may also be used with a conventional Fischer-Tropsch reactor. Alternatively, they may be used with the present reaction vessel, but run in reaction mode, without distillation.

Further, it will be appreciated that, the present reaction vessel may operate in the absence of trays, such as the trays depicted in FIGS. 1 and 3 for example, when intermediate collection of condensed liquid products is not desired. For example, packing material may alternate in the reaction vessel with reaction beds containing catalyst materials. Further, desired products may be refluxed towards the top of the reactor and collected from a product line towards the top of the reactor, or in one or more alternate lines, including any one intermediate product line. Still further, when the reaction vessel contains packing materials placed between reactor beds, in the absense of trays, undesired heavier by-products may be allowed to collect towards the bottom of the reactor and may be withdrawn from a product line towards the bottom of the reaction vessel.

### EXAMPLES

### Example 1

Pelleted Catalyst

Catalyst pellets 3 mm in diameter containing 20 wt % Cobalt with 0.5% Rhenium on gamma alumina were dumped into the reactor. Catalyst produced by standard incipient wetness techniques. The catalyst was reduced in the reactor at 350C with 50:50 mixture of H2/N2 for 16 hours. The overall space velocity during the runs were 2 NL/hr/g-cat. There were 4 catalyst sections each containing 10 grams of catalyst. The temperature was 225° C. at a pressure of 150 psig. The overhead product above the top catalyst section was condensed at 20° C. The entire condensed hydrocarbon stream was used as reflux after water removal via decanting. Overhead liquid product was recycled to the top of the reactor. Heavier liquid products were removed from the bottom of the reactor. Syn gas with a 2:1 ratio of H2/CO was fed at the bottom of the reactor.

| Run No. | Run 2 | Run 1 |
|---|---|---|
| CO Conversion | 100% | 100% |
| C5 + (g C5 + /hr/kg-cat) | 250 | 310 |
| Methane (wt % HC product) | 4% | 4% |
| CO2 from CO | 1% | 1% |

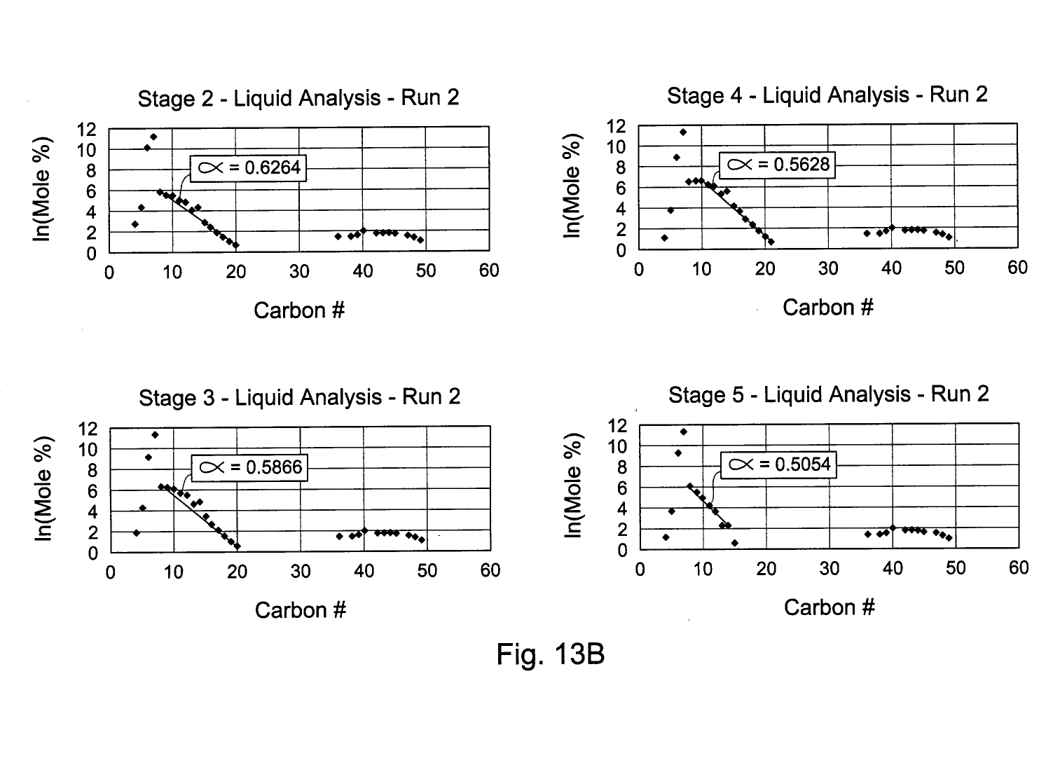

The carbon number distribution does not follow the standard Anderson-Schulz-Flory distribution common to Fischer-Tropsch. FIG. 13 shows that there is potential for significant chain limiting ability.

### Example 2

Pelleted Catalyst in a Structured Wire Mesh Packing Material

Catalyst pellets of 3 mm in diameter were rolled into a structured wire mesh packing material. The pellets were evenly distributed through out the packing. The catalyst pellets were identical to those used in Example 1. 20 grams catalyst was loaded into each of the four reactor sections. The catalyst was reduced identically as Example 1. Temperature of the reactor was 225° C. The space velocity was overall 2 NL/hr/g-catalyst. The syn gas feed was fed to two separate sections of catalyst at the lowest catalyst section and the second section from the top. The overhead product above the top catalyst section was condensed at 20° C. The entire condensed hydrocarbon stream was used as reflux after water removal via decanting. The overhead liquid product was refluxed to the top of the reactor and the next to the bottom catalyst section evenly. Syn gas feed was 2:1 ratio at both feed locations.

| Run No. | Run 1 | Run 2 |
|---|---|---|
| CO Conversion | 85% | 65% |
| C5 + (g C5 + /hr/kg-cat) | 200 | 80 |
| Methane (wt % HC product) | 13% | 30% |
| CO2 from CO | 9% | 12% |
| Pressure (psig) | 270 | 200 |

Without further elaboration, it is believed that one skilled in the art can, using the description herein, utilize the present invention to its fullest extent. While a preferred embodiment of the invention has been shown and described, modifications thereof can be made by one skilled in the art without departing from the spirit or teaching of this invention. The embodiments described herein are exemplary only and are not limiting. Many variations and modifications of the system and apparatus are possible and are within the scope of the invention. Accordingly, the scope of the protection is not limited to the embodiments described herein, but is only limited by the claims that follow, the scope of which shall include all equivalents of the subject matter of the claims.

We claim:

1. An apparatus for reacting chemicals to produce products and for separating the products, comprising:
a reaction vessel having a first zone with a first reactor and first distillation stage and a second zone with a second reactor and a second distillation stage;
said first and second reactors producing the products and said first and second distillation stages separating the products;
further including a first catalytic material disposed in said first reactor and a second catalytic material disposed in said second reactor;
wherein at least one of said first and second catalyst materials comprises a monolithic support substantially filling the cross-section of the corresponding one of said first and second reaction chambers.

2. An apparatus according to claim 2 wherein said support comprises a honeycomb monolith.

3. A catalytic distillation reactor comprising:according to claim 2 wherein said honeycomb monolith comprises from about 20 to about 30 channels/inch.

4. An apparatus according to claim 2, wherein said honeycomb monolith comprises from about 400 to about 900 channels/in².

5. An apparatus according to claim 2, wherein said honeycomb monolith comprises a channel having a portion having an axis disposed at a nonzero angle with respect to the axis of at the one of said reaction chambers containing said honeycomb monolith.

6. An apparatus according to claim 5 wherein said portion extends to all of said channel.

7. An apparatus according to claim 1 wherein said monolith comprises a foam monolith.

8. An apparatus according to claim 1 wherein said reactor is selected from the group consisting of a fixed bed reactor, a thin film reactor, a small diameter bubble column reactor, a counter current trickle-flow reactor, and a reactor containing a supercritical carrier fluid.

9. The apparatus of claim 1 wherein said zones are separated by trays.

10. The apparatus of claim 1 wherein said zones are separated by packing material.

11. The apparatus of claim 1 further including heat exchangers disposed exteriorly of said vessel in thermal flow communication with the products within said vessel.

12. The apparatus of claim 1 further including first and second feed lines communicating with first and second reactors, respectively, and first and second product lines exiting said first and second stages, respectively.

13. The apparatus of claim 12 wherein chemicals passing into first and second feed lines have different molar ratios.

14. The apparatus of claim 12 wherein products exiting first and second product lines have primarily different hydrocarbon chains.

15. The apparatus of claim 1 further including reflux lines communicating between said first and second zones.

16. The apparatus of claim 1 wherein said first and second zones have different conditions.

17. The apparatus of claim 16 wherein said first and second zones are different either in temperature, pressure or catalytic material.

18. The apparatus of claim 1 wherein liquid products migrate in one direction and gaseous products migrate in another direction through said zones.

19. The apparatus of claim 1 further including a water separator communicating with said vessel.

20. The apparatus of claim 1 further including a paraffin separator communicating with said vessel.

21. The apparatus of claim 1 wherein said vessel has a varying cross-sections.

22. The apparatus of claim 1 wherein said reactors and distillation stages operate simultaneously.

23. The apparatus of claim 1 wherein said first reactor produces first and second products and said second reactor produces substantially only said first product.

24. A catalytic distillation reactor comprising:
a reaction vessel having a plurality of distillation zones and a catalytic material in each of said distillation zones wherein at least one of said catalyst materials comprises a honeycomb monolith.

25. A catalytic distillation reactor according to claim 24 wherein at least one of said catalyst materials comprises a fixed bed.

26. A catalytic distillation reactor according to claim 24 wherein at least one of said catalyst materials comprises a fluidized bed.

27. A catalytic distillation reactor according to claim 24 wherein at least one of said catalyst materials comprises a slurry bed.

28. A catalytic distillation reactor according to claim 24 wherein said reactor is selected from the group consisting of a thin film reactor, a small diameter bubble column reactor, a counter current trickle-flow reactor, and a reactor containing a supercritical carrier fluid.

29. A catalytic distillation reactor according to claim 24 wherein each catalyst material is selected from the group consisting of fixed bed, fluidized bed, slurry bed, slurry bubble column and ebulliating bed.

30. A catalytic distillation reactor according to claim 24 wherein said catalyst material further comprises a metal catalyst selected from the group consisting of iron and cobalt.

31. A catalytic distillation reactor according to claim 24 further comprising a plurality of feed lines.

32. A catalytic distillation reactor according to claim 24 further comprising a plurality of product lines.

33. A catalytic distillation reactor according to claim 24 further comprising a reflux line or a recycle line.

34. A catalytic distillation reactor according to claim 24 further comprising means for cooling, wherein said means for cooling is positioned external to said reaction vessel.

35. A catalytic distillation reactor according to claim 24 wherein the diameter of said reaction vessel varies with respect to position along the axis of said reaction vessel.

36. A catalytic distillation reactor according to claim 24 wherein said reaction vessel further comprises a plurality of trays, wherein said trays as substantially perpendicular to the axis of said reaction vessel.

37. A catalytic distillation reactor according to claim 24 wherein said reaction vessel further comprises a plurality of trays, wherein said trays are position at an incline with respect to the axis of said reaction vessel.

38. A catalytic distillation reactor according to claim 24 further comprising a heating unit.

39. A catalytic distillation reactor according to claim 24 wherein at least one of said distillation zones comprises a tray with at least one of the following: bubble caps, weirs, filters, sieves, or sintered metal sieves.

40. A catalytic distillation reactor according to claim 24 wherein one of said distillation zones further comprises a heating unit.

41. A catalytic distillation reactor for Fischer-Tropsch synthesis of hydrocarbons comprising:
a reaction vessel;
a plurality of dividing members, said dividing members disposed inside said reaction vessel at a plurality of vertical locations so as to divide said reaction vessel into a plurality of reaction chambers;
at least one catalyst material positioned above at least one of said dividing members;
a plurality of feedlines entering said reaction vessel, said feedlines positioned so as to deposit materials in one or more of said reaction chambers;
a plurality of product lines, said product lines positioned so as to remove materials from one or more of said reaction chambers; and
an exchanger for transferring heat, said exchanger being external to said vessel.

42. The reactor according to claim 41 wherein said dividing member is a tray.

43. The reactor according to claim 41 wherein said dividing member is a structured packing.

44. A method for the Fischer-Tropsch synthesis of hydrocarbons comprising:
providing a catalytic distillation reactor comprising a reaction vessel, a plurality of distillation zones inside said reaction vessel, and a plurality of catalyst materials disposed in said distillation zones;
injecting reactants into said catalytic distillation reactor and removing hydrocarbon products from said catalytic distillation reactor; and
wherein at least one of said catalyst materials comprises a monolithic support substantially filling the cross-section of the corresponding one of said distillation zones.

45. A method for producing hydrocarbons according to claim 44 wherein said reactants comprise hydrogen and carbon monoxide.

46. A hydrocarbon product produced by the process of claims 44.
